(19) United States
(12) Patent Application Publication
(10) Pub. No.: US 2004/0252994 A1
(43) Pub. Date: Dec. 16, 2004

(54) Optical communication system with suppressed SBS

(76) Inventors: Scott R. Bickham, Corning, NY (US); Aleksandra Boskovic, Elmira, NY (US); A. Boh Ruffin, Painted Post, NY (US); Richard E. Wagner, Elmira, NY (US)

Correspondence Address: CORNING INCORPORATED, SP-TI-3-1, CORNING, NY, 14831

(21) Appl. No.: 10/837,867

(22) Filed: May 3, 2004

Related U.S. Application Data
(60) Provisional application No. 60/478,302, filed on Jun. 11, 2003.

(51) Int. Cl. H04B 10/08

(52) U.S. Cl. 398/26

(57) ABSTRACT

An optical communication system and a communication network are disclosed herein capable of transmitting optical signals with high optical launch power over long distances. A method of transmitting optical signals is also disclosed herein which comprises transmitting optical signals at high optical launch power with a high CNR and low CTB and CSO.

### CROSS-REFERENCE TO RELATED APPLICATIONS

This application claims the benefit of, and priority to U.S. Provisional Patent Application No. 60/478,302 filed on Jun. 11, 2003.

### BACKGROUND OF THE INVENTION

1. Field of the Invention

This invention relates to optical transmission systems and more specifically to a fiber optic transmission system capable of carrying a broadband signal over single mode optical fiber with high optical launch power.

2. Technical Background

Economical distribution of broadband signal content (such as multi-channel cable TV) over a single mode optical fiber system requires use of high optical signal powers. High optical signal powers enable the splitting of the optical signal for distribution over multiple fiber paths or alternatively transmission of signals over a single fiber path with a large link loss. The availability of efficient erbium doped fiber amplifiers (EDFAs) operating in the 1550 nm wavelength region, where standard telecommunication fiber exhibits its minimum attenuation, has motivated the development of broadband transmitters compatible with the gain bandwidth of EDFAs. However, standard telecommunication single mode fiber (e.g. Corning SMF-28 fiber) exhibits dispersion in the 1550 nm region, which precludes the use of directly modulated distributed feedback lasers (DFBs) as a transmitter for cable television. Instead, a typical transmitter operating at 1550 nm includes a narrow line width, externally modulated continuous wave (cw) DFB laser. The DFB laser light beam carries no information-bearing signals until the external modulation acts on the laser light beam to impress the information-bearing signals thereon. Here, “light” is not restricted to the visible spectrum. The optical power is amplified by an EDFA which is downstream from the external modulator. Thus the information bearing light signal enters the fiber optic span with an optical signal power determined by the saturated output power of the EDFA. Commercially available EDFAs offer saturated output powers exceeding 20 dBm.

As is well known, stimulated Brillouin scattering (SBS) is a nonlinear optical effect that poses a significant restriction to the amount of narrow-linewidth optical power that can be launched into a long length of single mode optical fiber. For a given length of single-mode fiber with a given attenuation coefficient at the chosen optical wavelength, there is an optical-linewidth-dependent threshold power below which SBS does not occur. For standard commercially available telecommunication fiber operating at 1550 nm, the SBS threshold for a cw optical source (laser) with an optical linewidth less than 10 MHz is less than 7 dBm for a fiber optic link of approximately 50 kilometer length.

Previously, in order to launch high optical signal powers in the 1550 nm wavelength region for transmission of broadband signals such as cable television over long fiber distances, one must suppress SBS. SBS creates excessive noise in the received signal, causes distortion, especially composite second order distortion, and induces power-dependent nonlinear attenuation in the fiber optic link, thereby also reducing the received optical power.

Hybrid multichannel AM-VSB and M-ary quadrature amplitude modulation (M-QAM) subcarrier-multiplexed video lightwave transmission systems are currently considered by both the telecom and cable industries as a promising technology for simultaneous delivery of both analog video and digital video/data services. Within the 50-860 MHz bandwidth, these systems can simultaneously carry up to about 134 channels of traditional broadcast AM-VSB signals and more than 30 channels of M-QAM digital signals using a single laser transmitter. Due to the fact that digital signals are more robust with respect to noise and nonlinear distortions, the operating point of these hybrid systems is largely dictated by the stringent carrier-to-noise ration (CNR) requirement of the AM channels. The analog portion is also limited by non-linear distortions, primarily of the second and third order, characterized by CSO and CTB. In order to maintain an acceptable CNR, the power budget of a video lightwave system based on a DFB laser transmitter has typically been limited to about 10 dB. This moderate power margin imposes an upper limit on the link length and number of optical splits. Applications such as long-distance video supertrunking and cable TV distribution and access architectures require a much higher power budget. One practical solution for boosting the link budges is to use erbium-doped fiber amplifiers (EDFA's) together with 1550-nm DFB laser transmitters. However, adding additional EFDA's can add significant system cost.

### SUMMARY OF THE INVENTION

An optical communication system is disclosed herein capable of transmitting optical signals with high optical launch power, and/or over greater distances than was previously thought possible while still maintaining acceptable levels of CNR, CSO, and CTB. The system is particularly advantageous for hybrid fiber-coaxial cable systems for cable TV and distribution networks and access networks, although the system is not limited thereto. The system preferably utilizes a single-mode fiber having a high SBS threshold. The system preferably comprises a point-to-multipoint optical network for transmitting optical data, and more preferably for transmitting and receiving optical data. The system enables higher optical launch powers and/or longer optical path distances from the optical signal source to a receiver.

Operation under a sub-carrier multiplexed (“SCM”) signal format is particularly suitable for all of the embodiments disclosed herein. Preferably, signals under the SCM signal format have an analog component.

As used herein, the output power of an optical signal source is the input power into the associated optical fiber.

Reference will now be made in detail to the present preferred embodiments of the invention, examples of which are illustrated in the accompanying drawings. An exemplary embodiment of a segmented core refractive index profile in accordance with the present invention is shown in each of the figures.

### BRIEF DESCRIPTION OF THE DRAWINGS

FIG. 1 schematic illustrates a communications network useful in cable TV or hybrid fiber-coaxial cable networks;

FIG. 2 is a schematic representation of the relative refractive index of an optical fiber suitable for use as disclosed herein;

FIG. 3 shows a graphical representation of the SBS threshold versus fiber length of optical fiber suitable for use as disclosed herein; and

FIG. 4 shows the measured reflected power as a function of input power for three optical fibers having lengths of about 50 km.

### DETAILED DESCRIPTION OF THE PREFERRED EMBODIMENT

Additional features and advantages of the invention will be set forth in the detailed description which follows and will be apparent to those skilled in the art from the description or recognized by practicing the invention as described in the following description together with the claims and appended drawings.

The “refractive index profile” is the relationship between refractive index or relative refractive index and waveguide fiber radius.

The “relative refractive index percent” is defined as Δ%=100×(nᵢ²−n_{c}²)/2nᵢ², where nᵢ is the maximum refractive index in region i, unless otherwise specified, and n_{c} is the average refractive index of the cladding region. In cases where the refractive index of an annular region or a segment is less than the average refractive index of the cladding region, the relative index percent is negative and is referred to as having a depressed region or depressed index, and is calculated at the point at which the relative index is most negative unless otherwise specified.

“Chromatic dispersion”, herein referred to as “dispersion” unless otherwise noted, of a waveguide fiber is the sum of the material dispersion, the waveguide dispersion, and the inter-modal dispersion. In the case of single mode waveguide fibers the inter-modal dispersion is zero. A zero-dispersion wavelength corresponds to a wavelength where the dispersion has a value of 0.

“Effective area” is defined as:

A_{eff}=2π(∫E²rdr)²/(∫E⁴rdr),

where the integration limits are 0 to ∞, and E is the electric field associated with light propagated in the waveguide.

The mode field diameter (MFD) is measured using the Peterman II method wherein, 2w=MFD, and w²=(2∫E²r dr/∫[dE/dr] r dr), the integral limits being 0 to ∞.

The bend resistance of a waveguide fiber can be gauged by induced attenuation under prescribed test conditions.

The “pin array” bend test is used to compare relative resistance of waveguide fiber to bending. To perform this test, attenuation loss is measured for a waveguide fiber with essentially no induced bending loss. The waveguide fiber is then woven about the pin array and attenuation again measured. The loss induced by bending is the difference between the two measured attenuations. The pin array is a set of ten cylindrical pins arranged in a single row and held in a fixed vertical position on a flat surface. The pin spacing is 5 mm, center to center. The pin diameter is 0.67 mm. During testing, sufficient tension is applied to make the waveguide fiber conform to a portion of the pin surface.

The theoretical fiber cutoff wavelength, or “theoretical fiber cutoff”, or “theoretical cutoff”, for a given mode, is the wavelength above which guided light cannot propagate in that mode. A mathematical definition can be found in Single Mode Fiber Optics, Jeunhomme, pp. 39-44, Marcel Dekker, New York, 1990 wherein the theoretical fiber cutoff is described as the wavelength at which the mode propagation constant becomes equal to the plane wave propagation constant in the outer cladding. This theoretical wavelength is appropriate for an infinitely long, perfectly straight fiber that has no diameter variations.

The effective fiber cutoff is lower than the theoretical cutoff due to losses that are induced by bending and/or mechanical pressure. In this context, the cutoff refers to the higher of the LP11 and LP02 modes. LP11 and LP02 are generally not distinguished in measurements, but both are evident as steps in the spectral measurement, i.e. no power is observed in the mode at wavelengths longer than the measured cutoff. The actual fiber cutoff can be measured by the standard 2m fiber cutoff test, FOTP-80 (EIA-TIA-455-80), to yield the “fiber cutoff wavelength”, also known as the “2m fiber cutoff” or “measured cutoff”. The FOTP-80 standard test is performed to either strip out the higher order modes using a controlled amount of bending, or to normalize the spectral response of the fiber to that of a multimode fiber.

The cabled cutoff wavelength, or “cabled cutoff” is even lower than the measured fiber cutoff due to higher levels of bending and mechanical pressure in the cable environment. The actual cabled condition can be approximated by the cabled cutoff test described in the EIA-445 Fiber Optic Test Procedures, which are part of the EIA-TIA Fiber Optics Standards, that is, the Electronics Industry Alliance—Telecommunications Industry Association Fiber Optics Standards, more commonly known as FOTP's. Cabled cutoff measurement is described in EIA-455-170 Cable Cutoff Wavelength of Single-mode Fiber by Transmitted Power, or “FOTP-170”.

An optical waveguide fiber link, as used herein, comprises an optical fiber or a plurality of optical fibers, or an optical fiber cable, or a plurality of optical fiber cables. An optical fiber cable comprises one or more optical fibers. An optical signal transmitted through an optical fiber travels through an associated optical fiber path length. The length of waveguide fiber can be made up of a plurality of shorter lengths that are spliced or connected together in end to end series arrangement. A link can include additional optical components such as optical amplifiers, optical attenuators, optical isolators, optical switches, optical filters, or multiplexing or demultiplexing devices. In preferred embodiments disclosed herein, an optical fiber link consists of optical fiber or optical fiber cable with no active components. As disclosed herein, an optical fiber link consists of optical fiber or optical fiber cable.

Carrier to Noise Ratio (CNR) is the ratio, given herein in decibels, of the carrier power to the average noise power, measured within a 4 MHz bandwidth for channels in the 45-560 MHz range.

Composite Second Order (CSO), when stated as a positive number, is the ratio of a channel carrier power to the aggregate distortion signal peak power found at ±0.75 MHz and ±1.25 MHz from the carrier frequency for channels in the 45-560 MHz range. This distortion is caused by second order nonlinear phenomena in the transmission system. It is often given as distortion power composite relative to the carrier, in decibels below the measured channel's carrier (−dBc), and this convention is used herein.

Composite Triple Beat (CTB) is the inverse ratio (in decibels) of the carrier power to the peak of the aggregate distortion signal found at the carrier frequency for channels in the 45-560 MHz range. This distortion is produced by third order nonlinearities in the transmission system and is reported herein in −dBc.

Unless stated otherwise herein, CNR, CSO, and CTB are measured for channels in the 45-560 MHz range.

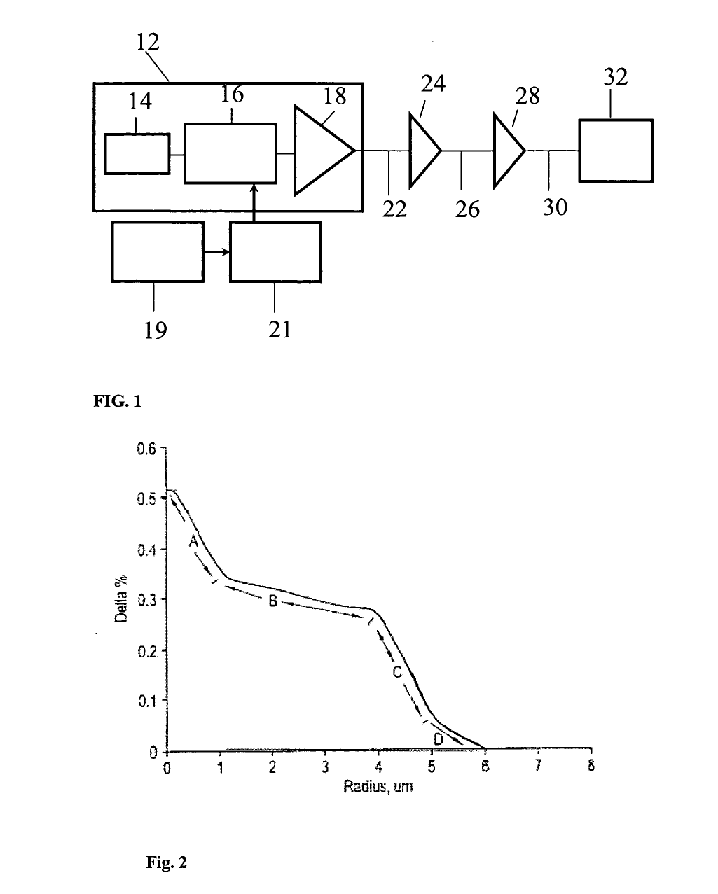

FIG. 1 schematically illustrates a communications network 10 which can be used in a telecommunications system. The communications network 10 illustrated in FIG. 1 has an optical transmitter 12, which in the embodiment illustrated consists of distributed feedback laser 14, external modulators 16, and erbium-doped amplifier 18. Optical transmitter 12 sends an optical signal into fiber span 20. The optical signal source is not limited to this type and can instead be of any type capable of transmitting an optical signal. Also illustrated, but not required, are a radio frequency signal generator 19 and predistortion circuit 21. In the embodiment illustrated in FIG. 1, optical fiber span 20 consists of a first length of optical fiber which makes up optical fiber link 22. Optical fiber link 22 optically connects optical transmitter 12 to a first optical amplifier (e.g. and EDFA). A second length of optical fiber makes up optical fiber link 26, which optically connects the first amplifier 24 to a second optical amplifier 28. A third length of optical fiber makes up optical fiber link 30 which connects the second amplifier 28 to receiver 32. A fiber link, as used herein, refers to a length of optical fiber which connects the signal source to an amplifier, or a first amplifier to a second amplifier, or an amplifier to a receiver, and so forth. Optical fiber span 20 includes all of the fiber links between the optical transmitter 12 and the receiver 32. Thus, in the embodiment illustrated in FIG. 1, the combined lengths of optical fiber links 22, 26, and 30 make up the length of optical fiber span 20. Preferably the fiber that makes up each of links 22, 26, and 30 is of the same fiber type.

While amplifiers are illustrated in the embodiment shown in FIG. 1, it will be understood from the description that such amplifiers are not necessary in various embodiments disclosed herein.

Receiver 30 may then connect to one or more additional optical fiber links or alternatively to one or more coaxial cable links, which in turn may then be connected to an end user downstream. The end user may be an apartment building office, or individual residence.

Stimulated Brillouin scattering in the optical distribution network 16 is preferably suppressed in all of the systems disclosed herein by utilizing optical fiber such as that disclosed in U.S. Pat. No. 6,490,396 or in U.S. patent application Ser. No. 10/818,054, the specifications of which are hereby incorporated by reference. In particular, implementation of such fiber in the optical fiber span 20 enhances SBS suppression. In preferred embodiments, all of the optical fiber in the optical fiber span 20 is of the same optical fiber type. A schematic representation of the relative refractive index of one such preferred optical fiber that can be used is shown in FIG. 2, which corresponds to FIG. 6 (A-B-C-D) of U.S. Pat. No. 6,490,396. Utilization of such optical fiber allows higher optical launch power into the optical distribution network 16 and/or allows a greater optical path length of the optical fiber span 20 than was previously thought possible without incurring SBS signal impairments. The optical fiber path length may differ from the actual physical distance by which the signal source and the receiver are separated, for example if the optical fiber or optical cable is at least partially coiled or folded or otherwise not fully extended in a straight line from the source to the receiver.

The optical fiber illustrated in FIG. 2 guides at least one optical mode and a plurality of acoustical modes, including an L₀₁ acoustical mode and an L₀₂ acoustical mode. The optical fiber comprises a core having a refractive index profile and a centerline and a cladding layer surrounding and directly adjacent the core. In a preferred embodiment, the core segment comprises a single core segment having a refractive index profile which decreases substantially continuously with radius. The effective area of the optical mode of such fibers at 1550 nm is greater than 70 μm², more preferably greater than 80 μm², and most preferably greater than 90 m 2. The L₋₀₁ acoustical mode has a first acousto-optic effective area, AOEA_{L01}, not less than 140 μm², more preferably not less than 150 μm², and most preferably not less than 160 μm at the Brillouin frequency of the optical fiber; the L₀₂ acoustical mode has a second acousto-optic effective area, AOEA_{L02}, not less than 140 μm², more preferably not less than 150 μm², and most preferably not less than 160 μm² at the Brillouin frequency of the optical fiber. Preferably, the relation of the L01 and L02 acoustic effective areas of the fibers are such that 0.4<AOEA_{L01}/AOEA_{L02}<2.5.

The relative refractive index of the core preferably lies between an upper boundary curve and a lower boundary curve. The upper boundary curve is a straight line defined by at least two points, including a first upper point having a Δ of 0.6% at a radius of 0 and a second upper point having a Δ of 0% at a radius of 14.25 μm. The lower boundary curve is a straight line defined by at least two points, including a first lower point having a Δ of 0.25% at a radius of 0 and a second lower point having a Δ of 0% at a radius of 6 μm.

Preferably, AOEA_{L01} and AOEA_{L02} are not less than 180 μm² at the Brillouin frequency of the optical fiber. More preferably, AOEA_{L01} and AOEA_{L02} are not less than 190 μm² at the Brillouin frequency of the optical fiber.

The optical fiber preferably exhibits a zero dispersion (or dispersion zero or λ₀) wavelength less than 1480 nm, more preferably less than 1400 nm, and most preferably less than 1340 nm.

In other preferred embodiments, the optical fiber has a zero dispersion at a wavelength below 1320 nm, more preferably in the range between 1290 and 1320 nm.

Preferably, the optical fiber has a dispersion of between 15 and 21 ps/nm-km at a wavelength of 1550 nm. In some preferred embodiments, the optical fiber has a dispersion of between 16 and 18 ps/nm-km at a wavelength of 1550 nm. In other preferred embodiments, the optical fiber has a dispersion of between 18 and 20 ps/nm-km at a wavelength of 1550 nm.

In preferred embodiments, the optical fiber has an optical effective area at 1550 nm of greater than 95 μm². In other preferred embodiments, the optical fiber has an optical effective area of greater than 100 μm².

Preferably the optical fiber has pin array bending loss at 1550 nm of less than 15 dB, more preferably less than 10 dB.

In some preferred embodiments, the upper boundary curve is a straight line defined by at least two points, including a first upper point having a Δ of 0.5% at a radius of 0 and a second upper point having a Δ of 0% at a radius of 11.25 μm;

In preferred embodiments, the core comprises a first portion extending from the centerline to a radius of 1 μm, the first portion having a relative refractive index greater than 0.25% and less than 0.5%.

Preferably, dΔ/dR>−0.15%μm for all radii from r=0 to r=1 μm. Preferably, the absolute magnitude of the difference between Δ(r=0 μm) and Δ(r=1 μm) is less than 0.1%.

The core further preferably comprises a second portion surrounding and directly adjacent to the first portion, the second portion extending to a radius of 2.5 μm and having Δ between 0.20% and 0.45%. In preferred embodiments, the second portion has a Δ between 0.3% and 0.45% for all radii between 1 and 1.5 μm. In other preferred embodiments, the second portion has a Δ between 0.2% and 0.35% for all radii between 1.5 and 2.5 μm.

The core further preferably comprises a third portion surrounding and directly adjacent to the second portion, the third portion extending to a radius of 4.5 μm and having Δ between 0.15% and 0.35%. In preferred embodiments, the third portion has a Δ between 0.2% and 0.3% for all radii between 2.5 and 4.5 μm.

Preferably, the absolute magnitude of the difference in A between any radii in the third portion is less than 0.1%.

Preferably, the absolute magnitude of the difference in Δ between any radii between r=2.5 ∥m and r=4.5 μm is less than 0.1%.

The core further preferably comprises a fourth portion surrounding and directly adjacent to the third portion, the fourth portion extending to a radius of 6 μm and having Δ between 0.1% and 0.3%. In preferred embodiments, the fourth portion has a Δ between 0.2% and 0.3% for all radii between 4.5 and 5 μm. In other preferred embodiments, the fourth portion has a Δ between 0.15% and 0.3% for all radii between 5 and 6 μm.

The core segment further preferably comprises a fifth portion surrounding and directly adjacent to the fourth portion, the fifth portion extending to a radius of 9 μm and having Δ between 0.0% and 0.15%.

In preferred embodiments, Δ(r=5.5 μm)>0.1%. Preferably, Δ(r=6 μm)>0%.

In preferred embodiments, A_{L01} and A_{L02} are less than 400 μm².

In preferred embodiments, 0.5<AOEA_{L01}/AOEA_{L02}<2, more preferably 0.6<AOEA_{L01}/AOEA_{L02}<1.5.

Preferably, the outermost radius of the core, r_{CORE}, is greater than 6 μm, more preferably greater than 6 μm and less than 15 μm, even more preferably greater than 6 μm and less than 12 μm. In preferred embodiments, rcoRE is between 6 μm and 10 μm.

Preferably the optical fiber described and disclosed herein allows suitable performance at a plurality of operating wavelength windows between about 1260 nm and about 1650 nm. More preferably, the optical fiber described and disclosed herein allows suitable performance at a plurality of wavelengths from about 1260 nm to about 1650 nm. In a preferred embodiment, the optical fiber described and disclosed herein is a dual window fiber which can accommodate operation in at least the 1310 nm window and the 1550 nm window.

Reference will now be made in detail to the present preferred embodiments of the invention, examples of which are illustrated in the accompanying drawings.

While the fibers in U.S. Pat. No. 6,490,396 and in U.S. Provisional Patent Application Ser. No. 60/467,676 are preferred, other fibers could also be employed. Preferably, the optical fiber for the optical fiber span 20 (including its length) is selected such that the SBS threshold of the fiber satisfies the following inequality:

$${P}_{th} > \frac{α {A}_{eff}}{{g}_{B}} {γ}_{B} \qquad ( 1 )$$

wherein

$${g}_{B} = \frac{{\tilde{g}}_{B} ( v )}{K ( 1 + Δ v / Δ {v}_{B} )} ,$$

\tilde{g}_{B}(ν) is Brillouin gain coefficient measured in m/W, 1≦K≦2 is the polarization factor, Δν and Δν_{B} are the full widths at half maximum (FWHM) of the laser source and of the Brillouin gain, respectively; wherein α is the fiber loss coefficient (attenuation), and A_{eff} is the fiber's effective area; wherein the dimensionless parameter γ_{B} is found as a solution of the following equation:

$$\frac{exp ⌊ - {γ}_{B} ( 1 - {ⅇ}^{- α L} ) ⌋}{( \frac{1}{{γ}_{B}} + {ⅇ}^{- α L} )} {γ}_{B}^{3 / 2} \sqrt{1 - {ⅇ}^{- α L}} = C ; \qquad ( 2 )$$

wherein L is the fiber length and the constant C is given by

$$C = \sqrt{π} k T \frac{{v}_{s}}{{v}_{a}} Δ {v}_{B} \frac{{g}_{B}}{α {A}_{eff}} ; \qquad ( 3 )$$

and wherein T is the fiber temperature, k is the Boltzmann constant, νₛ is the signal frequency, and ν_{α}≈11 GHz is the frequency difference between the Stokes wave and the signal wave. See J. Lightwave Technol., vol. 20, pp. 1635-1643, (2002).

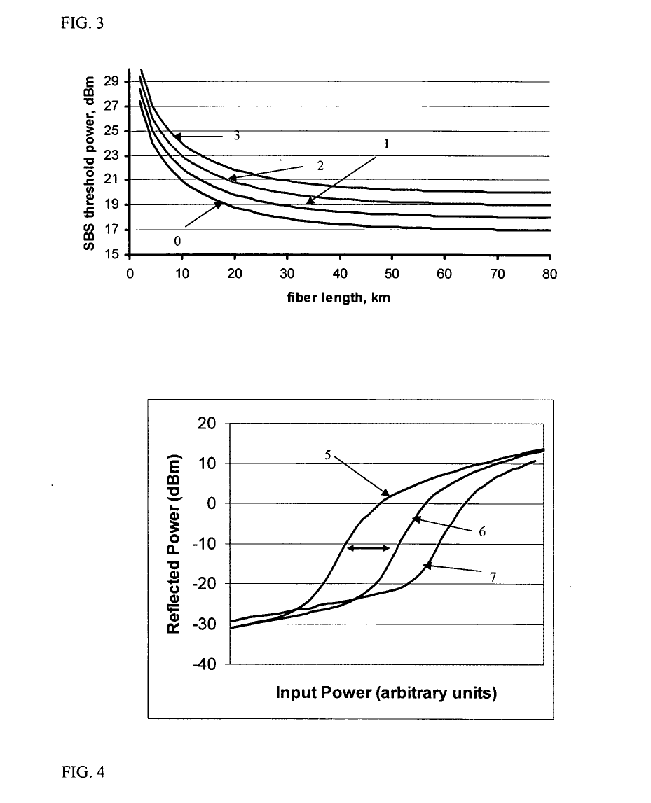

FIG. 3 shows the calculated SBS threshold plotted versus optical fiber path length for optical fibers with different inherent SBS thresholds. The SBS-suppression capability of an analog source is typically quoted for a 50 km sample of standard single mode fiber, such as Corning SMF-28® fiber. These fibers typically have an SBS threshold that ranges from about 7 dBm with a CW narrow-linewidth source to approximately 17 dBm with a source that is dithered.

FIG. 4 shows the measured reflected power as a function of input power for three optical fibers with lengths of about 50 km. Curve 5 corresponds to standard single mode fiber. Curves 6 and 7 correspond to fibers which exhibit SBS threshold increases above standard single mode fiber of 2.5 and 3.9 dBm, respectively, such as those disclosed in U.S. Pat. No. 6,490,396 and in U.S. patent application Ser. No. 10/818,054.

Preferably, the optical fiber in the trunk optical fiber link 20 has an SBS threshold that is at least 1 dB higher than that of standard single mode fiber, more preferably at least 2 dB higher, and even more preferably at least 3 dB higher. For access/CATV network applications, preferred optical fiber has an SBS threshold that is at least 2 dB higher than that of standard single mode fiber.

Curve 0 in FIG. 3 corresponds to standard single mode fiber. Curves 1, 2 and 3 of FIG. 3 correspond to fibers having respective 1 dB, 2 dB and 3 db increases in the SBS threshold of the fiber over standard single mode fiber. FIG. 3 shows that incremental 1 dB increases in the SBS threshold of the optical fiber result in available optical fiber path lengths of 10 km, 14 km and 18 km, respectively, for the same SBS threshold power of 22 dBm.

Operation below the SBS threshold of the optical fiber in trunk line 20 is preferred. Preferably, the maximum optical output power is about 1 dB below the actual SBS threshold of the optical fiber in the trunk link 20. More preferably, the maximum optical output power is about 2 dB below the actual SBS threshold of the optical fiber in the trunk link 20.

In a first set of preferred embodiments, an optical communication system is disclosed herein comprising: an optical signal source 12 for delivering an optical signal at an input power greater than 16 dBm and an optical signal distribution network comprising a length of optical fiber connecting the optical signal source 12 to a receiver 32, wherein the longest fiber link 22, 26, or 30 contained in the fiber path length 20 is greater than 45 km, and the signal is a subcarrier multiplexed signal, and wherein the system parameters are selected so that, in the operating wavelength range, CNR is greater than 50 dB, CSO is less than −60 dBc, and CTB is less than −60 dBc for channels in the 45 to 560 MHz range when the output power is greater than 16 dBm.

In all of the systems described herein, methods of operating such systems are also envisioned. For example, a method of operating a system according to the first set of preferred embodiments would entail inputting a signal from signal source 12 into optical fiber span 20, wherein the longest fiber link 22, 26, or 30 contained in the fiber path length 20 is greater than 45 km, and the signal is a subcarrier multiplexed signal, and wherein the system parameters are selected so that, in the operating wavelength range, CNR is greater than 50 dB, CSO is less than −60 dBc, and CTB is less than −60 dBc for channels in the 45 to 560 MHz range when the output power is greater than 16 dBm.

System parameters include the output power, signal phase modulation, signal dithering, bit rate, and optical fiber characteristics such as length, attenuation, and SBS threshold.

More preferably, the system parameters are selected so that substantially all of the channels in the 45 to 560 MHz range exhibit a CNR greater than 50 dB, CSO less than −65 dBc, and CTB less than −65 dBc at an output power greater than 16 dBm. Most preferably, the system parameters are selected so that, in the operating wavelength range, substantially all of the channels in the 45 to 560 MHz range exhibit CNR greater than 52 dB, CSO less than −60 dBc, and CTB less than −60 dBc when the output power is greater than 16 dBm. In another embodiment of the first set of preferred embodiments, the signal source output power is greater than 17 dBm, and the system parameters are selected so that, in the operating wavelength range, substantially all of the channels in the 45 to 560 MHz range exhibit CNR greater than 50 dB, CSO less than −60 dBc, and CTB less than −60 dBc when.

In yet another embodiment of the first set of preferred embodiments, the output power is greater than 18 dBm, and the system parameters are selected so that, in the operating wavelength range, substantially all of the channels in the 45 to 560 MHz range exhibit CNR greater than 50 dB, CSO less than −60 dBc, and CTB less than −60 dBc when the output power is greater than 18 dBm.

The longest fiber link contained in the fiber path length from the signal source to a first amplifier is preferably greater than 60 km, more preferably greater than 80 km.

In a second set of preferred embodiments, an optical communication system is disclosed herein comprising an optical signal source 12 for delivering an optical signal at an input power greater than 16 dBm and an optical signal distribution network comprising a length of optical fiber span 20 connecting the optical signal source to a receiver, wherein the fiber path length from the signal source to the receiver is greater than 50 km, and the path length does not include an optical amplifier, and the signal is a subcarrier multiplexed signal, and and wherein the system parameters are selected so that, in the operating wavelength range, CNR is greater than 50 dB, CSO is less than −60 dBc, and CTB is less than −60 dBc for channels in the 45 to 560 MHz range when the output power is greater than 16 dBm.

In one preferred embodiment of the first set of preferred embodiments, the fiber span 20 path length is greater than about 70 km, more preferably greater than about 80 km, and most preferably greater than about 90 km, and the system parameters are selected so that, in the operating wavelength range, substantially all of the channels in the 45 to 560 MHz range exhibit CNR greater than 50 dB, CSO less than −60 dBc, and CTB less than −60 dBc when the output power is greater than 17 dBm. More preferably, the system parameters are selected so that, in the operating wavelength range, substantially all of the channels in the 45 to 560 MHz range exhibit CNR greater than 50 dB, CSO less than −60 dBc, and CTB less than −60 dBc when the output power is greater than 18 dBm. Most preferably, the system parameters are selected so that, in the operating wavelength range, substantially all of the channels in the 45 to 560 MHz range exhibit CNR greater than 50 dB, CSO less than −60 dBc, and CTB less than −60 dBc when the output power is greater than 19 dBm.

In a third set of preferred embodiments, an optical communication system is disclosed herein comprising an optical signal source 12 for delivering an optical signal at an input power greater than 16 dBm and an optical signal distribution network comprising a length of optical fiber span 20 connecting the optical signal source 12 to a receiver 32, wherein the fiber span 20 path length from the signal source 12 to the receiver 32 is greater than 120 km, and wherein the system parameters are selected so that, in the operating wavelength range, CNR is greater than 50 dB, CSO is less than −60 dBc, and CTB is less than −60 dBc for channels in the 45 to 560 MHz range when the output power is greater than 16 dBm.

In preferred embodiments of the third set of preferred embodiments, the fiber employed in said fiber path comprises a zero dispersion wavelength less than 1400 nm.

The fiber path may include one or more optical amplifiers 24, 28 to further lengthen the total distance possible between the signal source and the receiver. Preferably, output power is greater than 18 dBm and the system parameters are selected so that, in the operating wavelength range, substantially all of the channels in the 45 to 560 MHz range exhibit CNR greater than 50 dB, CSO less than −60 dBc, and CTB less than −60 dBc. More preferably, the output power is greater than 20 dBm and the system parameters are selected so that, in the operating wavelength range, substantially all of the channels in the 45 to 560 MHz range exhibit CNR greater than 50 dB, CSO less than −60 dBc, and CTB less than −60 dBc.

In a fourth set of preferred embodiments, an optical communication system is disclosed which comprises an optical signal source 12 for delivering an optical signal at an input power greater than 14 dBm and an optical signal distribution network comprising a length of optical fiber 20 connecting the optical signal source 12 to a receiver 32, wherein the fiber span 20 path length from the signal source to the receiver is greater than 50 km, the fiber exhibits a zero dispersion wavelength less than 1400 nm, and wherein the system parameters are selected so that, in the operating wavelength range, CNR is greater than 50 dB, CSO is less than −60 dBc, and CTB is less than −60 dBc for channels in the 45 to 560 MHz range when the output power is greater than 14 dBm.

Preferably, the output power is greater than 15 dBm and the system parameters are selected so that, in the operating wavelength range, substantially all of the channels in the 45 to 560 MHz range exhibit CNR greater than 50 dB, CSO less than −60 dBc, and CTB less than −60 dBc. Even more preferably, output power is greater than 16 dBm and the system parameters are selected so that, in the operating wavelength range, substantially all of the channels in the 45 to 560 MHz range exhibit CNR greater than 50 dB, CSO less than −60 dBc, and CTB less than −60 dBc. Most preferably, the output power is greater than 18 dBm and the system parameters are selected so that, in the operating wavelength range, substantially all of the channels in the 45 to 560 MHz range exhibit CNR greater than 50 dB, CSO less than −60 dBc, and CTB less than −60 dBc.

The fiber path length 20 in the fourth preferred embodiment is preferably greater than about 70 km, more preferably, greater than about 80 km, and most preferably greater than about 90 km.

In a fifth set of preferred embodiments, an optical communication system is disclosed which comprises an optical signal source 12 for delivering an optical signal at an input power greater than 19 dBm and an optical signal distribution network comprising a length of optical fiber 20 connecting the optical signal source 12 to a receiver 32, wherein the fiber path length from the signal source to the receiver is greater than 90 km, the signal is a subcarrier multiplexed signal, and and wherein the system parameters are selected so that, in the operating wavelength range, CNR is greater than 50 dB, CSO is less than −60 dBc, and CTB is less than −60 dBc for channels in the 45 to 560 MHz range when the output power is greater than 19 dBm.

More preferably, output power is greater than 20 dBm and the system parameters are selected so that, in the operating wavelength range, substantially all of the channels in the 45 to 560 MHz range exhibit CNR greater than 50 dB, CSO less than −60 dBc, and CTB less than −60 dBc. Even more preferably, the output power is greater than 21 dBm and the system parameters are selected so that, in the operating wavelength range, substantially all of the channels in the 45 to 560 MHz range exhibit CNR greater than 50 dB, CSO less than −60 dBc, and CTB less than −60 dBc. Most preferably, the output power is greater than 22 dBm and the system parameters are selected so that, in the operating wavelength range, substantially all of the channels in the 45 to 560 MHz range exhibit CNR greater than 50 dB, CSO less than −60 dBc, and CTB less than −60 dBc.

With regard to any of the above sets of preferred embodiments, additional preferred embodiments include the optical signal source comprising a transmitter and an amplifier for amplifying the optical signal generated by the transmitter.

With regard to any of the above sets of preferred embodiments, additional preferred embodiments include the transmitter generating optical signals at a plurality of wavelengths.

Preferably, at least one optical signal is transmitted at a wavelength within an operating wavelength range between 1530 nm and 1565 nm. In a preferred embodiment, the optical signal is transmitted at a wavelength of about 1550 nm. In another preferred embodiment, at least one optical signal is transmitted at a wavelength within a wavelength range between 1460 nm and 1520 nm. In one preferred embodiment, the optical signal is transmitted at a wavelength of about 1490 nm.

It is to be understood that the foregoing description is exemplary of the invention only and is intended to provide an overview for the understanding of the nature and character of the invention as it is defined by the claims. The accompanying drawings are included to provide a further understanding of the invention and are incorporated and constitute part of this specification. The drawings illustrate various features and embodiments of the invention which, together with their description, serve to explain the principals and operation of the invention. It will become apparent to those skilled in the art that various modifications to the preferred embodiment of the invention as described herein can be made without departing from the spirit or scope of the invention as defined by the appended claims.

What is claimed is:

1. An optical communication system comprising:
an optical signal source for delivering an optical signal at an input power greater than 16 dBm and an optical signal distribution network comprising a length of optical fiber connecting the optical signal source to a receiver,
wherein the longest fiber link, connecting one of a transmitter, amplifier, or receiver with another of a transmitter, amplifier, or receiver, contained in the fiber path length from the signal source to the receiver is greater than 45 km, and the signal is a subcarrier multiplexed signal, and wherein the system parameters are selected so that, in the operating wavelength range, CNR is greater than 50 dB, CSO is less than −60 dBc, and CTB is less than −60 dBc for channels in the 45 to 560 MHz range when the output power is greater than 16 dBm.

2. The communication system of claim 1, wherein substantially all of the channels in the 45 to 560 MHz range exhibit a CNR greater than 50 dB, CSO less than −65 dBc, and CTB less than −65 dBc at an output power greater than 16 dBm.

3. The communication system of claim 1, wherein the system parameters are selected so that, in the operating wavelength range, substantially all of the channels in the 45 to 560 MHz range exhibit CNR greater than 52 dB, CSO less than −60 dBc, and CTB less than −60 dBc when the output power is greater than 16 dBm.

4. The communication system of claim 1, wherein the system parameters are selected so that, in the operating wavelength range, substantially all of the channels in the 45 to 560 MHz range exhibit CNR greater than 50 dB, CSO less than −60 dBc, and CTB less than −60 dBc when the output power is greater than 17 dBm.

5. The communication system of claim 1, wherein the system parameters are selected so that, in the operating wavelength range, substantially all of the channels in the 45 to 560 MHz range exhibit CNR greater than 50 dB, CSO less than −60 dBc, and CTB less than −60 dBc when the output power is greater than 18 dBm.

6. The communication system of claim 1, wherein the longest fiber link contained in the fiber path length from the signal source to a first amplifier is greater than 60 km.

7. The communication system of claim 1, wherein the longest fiber link contained in the fiber path length from the signal source to a first amplifier is greater than 60 km.

8. An optical communication system comprising:
an optical signal source for delivering an optical signal at an input power greater than 16 dBm and an optical signal distribution network comprising a length of optical fiber connecting the optical signal source to a receiver,
wherein the fiber path length from the signal source to the receiver is greater than _{—}50_km, and the path length does not include an optical amplifier, and the signal is a subcarrier multiplexed signal, and and wherein the system parameters are selected so that, in the operating wavelength range, CNR is greater than 50 dB, CSO is less than −60 dBc, and CTB is less than −60 dBc for channels in the 45 to 560 MHz range when the output power is greater than 16 dBm.

9. The communications system of claim 8, wherein the fiber path length is greater than about 70 km

10. The communications system of claim 8, wherein the fiber path length is greater than about 80 km

11. The communications system of claim 8, wherein the fiber path length is greater than about 90 km

12. The communications system of claim 8, wherein the wherein the system parameters are selected so that, in the operating wavelength range, substantially all of the channels in the 45 to 560 MHz range exhibit CNR greater than 50 dB, CSO less than −60 dBc, and CTB less than −60 dBc when the output power is greater than 17 dBm.

13. The communications system of claim 8, wherein the wherein the system parameters are selected so that, in the operating wavelength range, substantially all of the channels in the 45 to 560 MHz range exhibit CNR greater than 50 dB, CSO less than −60 dBc, and CTB less than −60 dBc when the output power is greater than 18 dBm.

14. The communications system of claim 8, wherein the wherein the system parameters are selected so that, in the operating wavelength range, substantially all of the channels in the 45 to 560 MHz range exhibit CNR greater than 50 dB, CSO less than −60 dBc, and CTB less than −60 dBc when the output power is greater than 19 dBm.

15. An optical communication system comprising:
an optical signal source for delivering an optical signal at an input power greater than 16 dBm and an optical signal distribution network comprising a length of optical fiber connecting the optical signal source to a receiver,
wherein the fiber path length from the signal source to the receiver is greater than _{—}120_km, and wherein the system parameters are selected so that, in the operating wavelength range, CNR is greater than 50 dB, CSO is less than −60 dBc, and CTB is less than −60 dBc for channels in the 45 to 560 MHz range when the output power is greater than 16 dBm.

16. The communications system of claim 15, wherein the fiber employed in said fiber path comprises a zero dispersion wavelength less than 1400 nm.

17. The communications system of claim 15, wherein the fiber path includes at least one optical amplifer.

18. The communications system of claim 15, wherein the fiber path includes at least two optical amplifers.

19. The communications system of claim 15, wherein the wherein the system parameters are selected so that, in the operating wavelength range, substantially all of the channels in the 45 to 560 MHz range exhibit CNR greater than 50 dB, CSO less than −60 dBc, and CTB less than −60 dBc when the output power is greater than 18 dBm.

20. The communications system of claim 15, wherein the wherein the system parameters are selected so that, in the operating wavelength range, substantially all of the channels in the 45 to 560 MHz range exhibit CNR greater than 50 dB, CSO less than −60 dBc, and CTB less than −60 dBc when the output power is greater than 20 dBm.

21. An optical communication system comprising:
an optical signal source for delivering an optical signal at an input power greater than 14 dBm and an optical signal distribution network comprising a length of optical fiber connecting the optical signal source to a receiver,
wherein the fiber path length from the signal source to the receiver is greater than 50 km, the fiber exhibits a zero dispersion wavelength less than 1400 nm, and wherein the system parameters are selected so that, in the operating wavelength range, CNR is greater than 50 dB, CSO is less than −60 dBc, and CTB is less than −60 dBc for channels in the 45 to 560 MHz range when the output power is greater than 14 dBm.

22. The communications system of claim 21, wherein the wherein the system parameters are selected so that, in the operating wavelength range, substantially all of the channels in the 45 to 560 MHz range exhibit CNR greater than 50 dB, CSO less than −60 dBc, and CTB less than −60 dBc when the output power is greater than 15 dBm.

23. The communications system of claim 21, wherein the wherein the system parameters are selected so that, in the operating wavelength range, substantially all of the channels in the 45 to 560 MHz range exhibit CNR greater than 50 dB, CSO less than −60 dBc, and CTB less than −60 dBc when the output power is greater than 16 dBm.

24. The communications system of claim 21, wherein the wherein the system parameters are selected so that, in the operating wavelength range, substantially all of the channels in the 45 to 560 MHz range exhibit CNR greater than 50 dB, CSO less than −60 dBc, and CTB less than −60 dBc when the output power is greater than 18 dBm.

25. The communications system of claim 21, wherein the fiber path length is greater than about 70 km

26. The communications system of claim 21, wherein the fiber path length is greater than about 80 km

27. The communications system of claim 21, wherein the fiber path length is greater than about 90 km

28. An optical communication system comprising:
an optical signal source for delivering an optical signal at an input power greater than 19 dBm and an optical signal distribution network comprising a length of optical fiber connecting the optical signal source to a receiver,
wherein the fiber path length from the signal source to the receiver is greater than _{—}90_km, the signal is a subcarrier multiplexed signal, and and wherein the system parameters are selected so that, in the operating wavelength range, CNR is greater than 50 dB, CSO is less than −60 dBc, and CTB is less than −60 dBc for channels in the 45 to 560 MHz range when the output power is greater than 19 dBm.

29. The communications system of claim 28, wherein the wherein the system parameters are selected so that, in the operating wavelength range, substantially all of the channels in the 45 to 560 MHz range exhibit CNR greater than 50 dB, CSO less than −60 dBc, and CTB less than −60 dBc when the output power is greater than 20 dBm.

30. The communications system of claim 28, wherein the wherein the system parameters are selected so that, in the operating wavelength range, substantially all of the channels in the 45 to 560 MHz range exhibit CNR greater than 50 dB, CSO less than −60 dBc, and CTB less than −60 dBc when the output power is greater than 21 dBm.

31. The communications system of claim 28, wherein the wherein the system parameters are selected so that, in the operating wavelength range, substantially all of the channels in the 45 to 560 MHz range exhibit CNR greater than 50 dB, CSO less than −60 dBc, and CTB less than −60 dBc when the output power is greater than 22 dBm.

32. An optical communication system comprising an optical signal source for delivering an optical signal at an input power greater than 14 dBm and an optical signal distribution network comprising a length of optical fiber connecting the optical signal source to a receiver, the fiber exhibiting an L₀₁ acoustical mode having a first acousto-optic effective area, AOEA_{L01}, not less than 140 μm² and an L₀₂ acoustical mode having a second acousto-optic effective area, AOEA_{L02}, not less than 140 μm², both of said first and second acousto-optic effective areas measured at the Brillouin frequency of the optical fiber, wherein the longest fiber link contained in the fiber path length from the signal source to a first amplifier is greater than 45 km, and the signal is a subcarrier multiplexed signal, and wherein the system parameters are selected so that, in the operating wavelength range, CNR is greater than 50 dB, CSO is less than −60 dBc, and CTB is less than −60 dBc for channels in the 45 to 560 MHz range when the output power is greater than 16 dBm.

33. The communications system of claim 32 wherein the relation of the L01 and L02 acoustic effective areas of the fiber is such that 0.4<AOEA_{L01}/AOEA_{L02}<2.5.
